(19) United States
(12) Patent Application Publication
(10) Pub. No.: US 2014/0048989 A1
(43) Pub. Date: Feb. 20, 2014

(54) VIBRATION ISOLATION SYSTEMS

(71) Applicant: David L. Platus, Santa Monica, CA (US)

(72) Inventor: David L. Platus, Santa Monica, CA (US)

(73) Assignee: MINUS K. TECHNOLOGY, INC., Inglewood, CA (US)

(21) Appl. No.: 13/587,135

(22) Filed: Aug. 16, 2012

(51) Int. Cl. F16F 15/02

(52) U.S. Cl. 267/140.5

(57) ABSTRACT

A composite vibration isolation system utilizes isolators with negative-stiffness mechanisms to produce low vertical and horizontal natural frequencies to the system by allowing both the horizontal stiffness and horizontal natural frequencies to be adjusted, for example, by turning adjustment screws.

### BACKGROUND OF THE INVENTION

This invention relates generally to suspension systems for isolating and reducing the transmission of vibratory motion between an object or payload and a base and, more particularly, to an omnidirectional suspension or vibration-isolating system which exhibits low stiffness both vertically in the direction of the weight load and horizontally in directions transverse to the weight load to effectively reduce the transmission of vibrations between the object and the base. The present invention represents improvements over my previous isolators which utilize negative-stiffness mechanisms to produce low vertical and horizontal natural frequencies and which rely on a principle of loading a particular elastic structure which forms the isolator or a portion of it to approach the elastic structure's point of elastic instability.

The problems caused by unwanted vibration on equipment, devices and processes that are extremely motion sensitive have been widely researched and numerous solutions to prevent or reduce the transmission of vibratory motion have been proposed and developed. Many of the devices designed to reduce the transmission of unwanted vibration between an object and its surroundings, commonly called vibration isolators or suspension devices, have utilized various combinations of elements such as resilient pads made from a variety of materials, various types of mechanical springs, and pneumatic devices. There are, however, shortcomings and disadvantages associated with these particular prior art isolation systems which prevent them from obtaining low system natural frequencies and from limiting resonant responses to low values while providing high isolation performance at the higher frequencies.

These shortcomings and disadvantages of prior art systems were addressed through the development of novel vibration isolation systems devices described in U.S. Pat. No. 5,530,157, entitled “Vibration Isolation System” issued May 10, 1994, U.S. Pat. No. 5,370,352, entitled “Damped Vibration System” issued Dec. 6, 1994, U.S. Pat. No. 5,178,357, entitled “Vibration Isolation System” issued Jan. 12, 1993, U.S. Pat. No. 5,549,270, entitled “Vibration Isolation System” issued Aug. 27, 1996, U.S. Pat. No. 5,669,594, entitled “Vibration Isolation System” issued Sep. 23, 1997, U.S. Pat. No. 5,833,204, entitled “Radial Flexures, Beam-Columns and Tilt Isolation for a Vibration Isolation System issued Nov. 10, 1998, which are all hereby incorporated by reference in this present application. These vibration isolators exhibit low stiffness, high damping to limit resonant responses of the composite system, effective isolation at the higher frequencies, and can provide high isolator resonant frequencies.

The particular vibration isolation systems described in these patents, and utilized in connection with the present invention, provide versatile vibration isolation by exhibiting low stiffness in an axial direction (generally the direction of the payload weight) and any direction substantially transverse to the axial direction (generally a horizontal direction), and may provide tilt or rotation about three mutually perpendicular axes. One particular system utilizes a combination of uni-directional or bi-directional isolator subassemblies that can be connected together in series fashion to provide omni-directional isolation. Each isolator is designed to isolate the axial or the transverse component of any vibratory translation to effectively isolate vibrations along or about any directional axes. In subsequent discussions, an axial-motion isolator will be referred to as a vertical-motion isolator, and the system of axial-motion isolators will be referred to as the vertical-motion isolation system. Similarly, a transverse-motion isolator will be referred to as a horizontal-motion isolator, and the system of transverse-motion isolators will be referred to as the horizontal-motion isolation system. Lastly, a tilt-motion isolator in conjunction with a structure allowing rotation about the tilt axes will be referred to as the tilt-motion isolation system. The tilt axes are transverse to the axial direction and usually lie in the horizontal plane.

In the embodiments described in the above-noted patents, the isolators rely on a particular principle of loading a particular elastic structure which forms the isolator or a portion of it (the loading being applied by either the supported weight or by an external loading mechanism) to approach the elastic structure's point of elastic instability. This loading to approach the point of elastic instability, also called the “critical buckling load” of the structure, causes a substantial reduction of either the vertical or the horizontal stiffness of the isolator to create an isolation system that has low stiffness in the vertical and in any horizontal direction, and increases the damping inherent in the structure. While stiffness is reduced, these isolators still retain the ability to support the payload weight.

In the event that the load on the elastic structure is greater than the critical buckling load, the excessive load will tend to propel the structure into its buckled shape, creating a “negative-stiffness” or “negative-spring-rate” mechanism. By combining a negative-stiffness mechanism with a spring, adjusted so that the negative stiffness cancels or nearly cancels the positive stiffness of the spring, one obtains a device that can be placed at or near its point of elastic instability. The magnitude of the load causing the negative stiffness can be adjusted, creating an isolator that can be “fine-tuned” to the particular stiffness desired.

These above-described isolators provide excellent systems for isolating or reducing the transmission of vibratory motion between an object and the base by exhibiting low stiffness and low resonant frequencies and effective isolation at the higher frequencies, while being capable of accommodating different weight loads without significantly degrading the vertical isolation system performance. However, in my previous isolators described in the above-noted patents, only the vertical stiffness and vertical natural frequency could be adjusted or “fined tuned,” for example, by turning an adjustment screw. The horizontal natural frequency could only be adjusted by changing the weight load that was being supported by the horizontal-motion isolator. It would be beneficial if an omnidirectional vibration isolation system included a mechanism which allows the horizontal-motion isolator to be fined tuned as well. In this regard, the particular stiffness attained by the horizontal isolator of the system could be adjusted as need for a particular application. The present inventions solve this and other needs.

### SUMMARY OF THE INVENTION

The present invention represents improvements over my previous isolation systems utilizing isolators with negative-stiffness mechanisms to produce low vertical and horizontal natural frequencies by allowing both the horizontal stiffness and horizontal natural frequencies to be adjusted, for example, by turning adjustment screws. In my previous isolators, only the vertical stiffness and vertical natural frequency could be adjusted by turning an adjustment screw. The horizontal natural frequency attained by the horizontal-motion isolator could only be adjusted by changing the weight load being borne by the horizontal-motion isolator. The present invention also provides a composite isolator system having fewer and simpler parts which cost less to manufacture than my previous isolators.

My previous inventions utilized negative-stiffness mechanisms to provide vibration isolation systems capable of supporting an object having weight (an object with mass in a gravitational field) and providing low stiffness and low natural frequencies in both the vertical (gravity) direction and in the lateral or horizontal directions. The low horizontal stiffness and low horizontal natural frequencies were achieved by using the weight of the object to load vertically oriented beam-columns close to their critical buckling loads (the loads at which their lateral stiffness becomes zero). This approach made use of the “beam-column” effect, which refers to the reduction in the bending stiffness of a beam when it is loaded in compression to make the beam behave as a beam-column. It can be shown that the beam-column effect in a vertically oriented beam-column is equivalent to a horizontal spring and a negative-stiffness mechanism, and the magnitude of the negative stiffness increases with an increase in the weight load. The low vertical stiffness and low vertical natural frequency was achieved by using a support spring connected to a negative-stiffness mechanism in the form of horizontally oriented beam-columns which are spring loaded in compression so that the negative stiffness removes much of the stiffness of the support spring and the stiffness of the beam-columns. These vibration isolation systems are used to isolate vibration-sensitive objects from the vertical and horizontal vibrations of a vibrating support, i.e., to reduce the magnitude of the vibrations transmitted from the vibrating support to the object.

The present invention provides an arrangement of isolators in which the payload weight is supported by the vertical-motion isolator and not by the vertically oriented beam-columns that comprise the horizontal-motion isolator as is described in my previous patents. The beam-columns comprise only part of the horizontal-motion isolator in the present isolation system. In my previous inventions, the vertical-motion and horizontal-motion isolators were operationally connected in series so that both isolators carried the payload weight. In the present invention, the horizontal-motion isolator still utilizes vertically oriented beam-columns that are part of the horizontal-motion vibration isolation system; however, the beam-columns are designed and arranged relative to the vertical-motion isolator so as not to support the payload weight. In the present invention a support spring that is part of the vertical-motion isolator is also part of the horizontal-motion isolator and, in one simple embodiment, has low horizontal stiffness.

In one simple embodiment of the present invention, the composite isolator achieves low horizontal stiffness and low horizontal natural frequencies by utilizing a vertical-support spring having low horizontal stiffness, along with vertically oriented beam-columns that possess low horizontal stiffness without the need to rely on the beam-column effect that results when the beam-columns support the payload weight. The beam-columns can be designed to possess low horizontal stiffness because they no longer are used to support the payload weight. The vertical support spring with its low horizontal stiffness that supports the entire weight of the payload, along with a negative-stiffness mechanism that reduces the vertical stiffness, and the beam-columns having low horizontal stiffness, thus provide the vibration isolation features needed for achieving suitable vibration isolation in this simplest embodiment of the present invention.

In another aspect of the present invention, a loading mechanism (horizontal stiffness adjustment mechanism) can be utilized to load the vertically oriented beam-columns to attain a desired low stiffness. In this regard, the horizontal stiffness of the vertically oriented beam-columns and the vertical support spring could be initially significant but can be lowered, if needed, by simply adding a compressive load via the horizontal stiffness adjustment mechanism. The horizontal stiffness of the horizontal-motion isolator could thus be lowered to a desired range for a particular application.

In other aspects of the present invention, when a horizontal stiffness adjustment mechanism is used to reduce the horizontal stiffness of the beam-columns and the vertical support spring, it is advantageous to use a support spring with relatively high stiffness in yaw or rotation about the vertical axis, but retaining the same vertical and horizontal stiffness properties. This can be achieved, for example, with die springs and bellows. In my previous inventions, a round wire coil spring was primarily used in the vertical-motion isolators.

All in all, the present inventions provide improvements to the vibration isolation systems described in my issued patents by providing a horizontal-motion isolation system that provides effective horizontal-motion isolation to the composite system that can be adjusted by turning adjustment screws, and a simpler composite vibration isolation system having fewer and simpler parts that cost less to manufacture. Other features and advantages of the present invention will become apparent from the following detailed description when taken in conjunction with the accompanying drawings which illustrate, by way of example, the principles of the present invention.

### BRIEF DESCRIPTION OF THE DRAWINGS

FIG. 1A is a perspective view of one embodiment of a vibration isolation system made in accordance with the present invention;

FIG. 1B is cross sectional view taken along line 1B-1B of FIG. 1A;

FIG. 1C is an expanded view of the lift mechanism shown FIGS. 1A and 1B;

FIG. 2 is an elevational view of the vibration isolation system shown in FIG. 1A;

FIG. 3 is side elevational view of the vibration isolation system shown in FIG. 1A;

FIG. 4 is a perspective view of another embodiment of a vibration isolation system made in accordance with the present invention;

FIG. 5 is an elevational view of the vibration isolation system shown in FIG. 4;

FIG. 6 is a side elevational view of the vibration isolation system shown in FIG. 4;

FIG. 7 is a perspective view of another embodiment of a vibration isolation system made in accordance with the present invention;

FIG. 8 is an elevational view of the vibration isolation system shown in FIG. 7; and

FIG. 9 is a side elevational view of the vibration isolation system shown in FIG. 7.

### DETAILED DESCRIPTION OF THE PREFERRED EMBODIMENTS

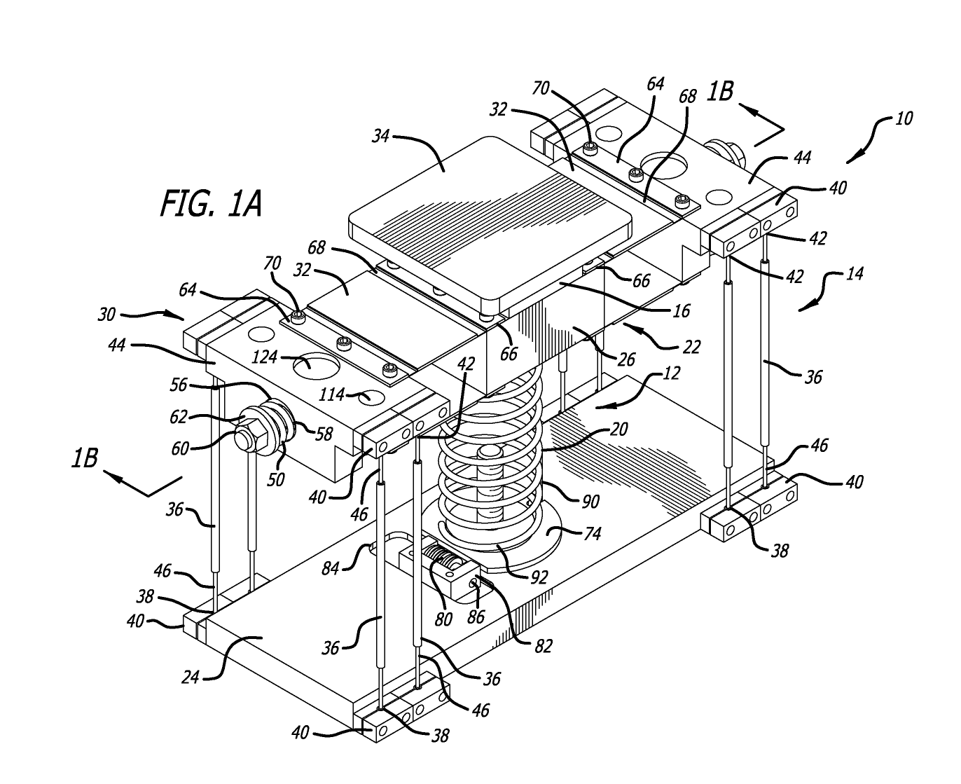

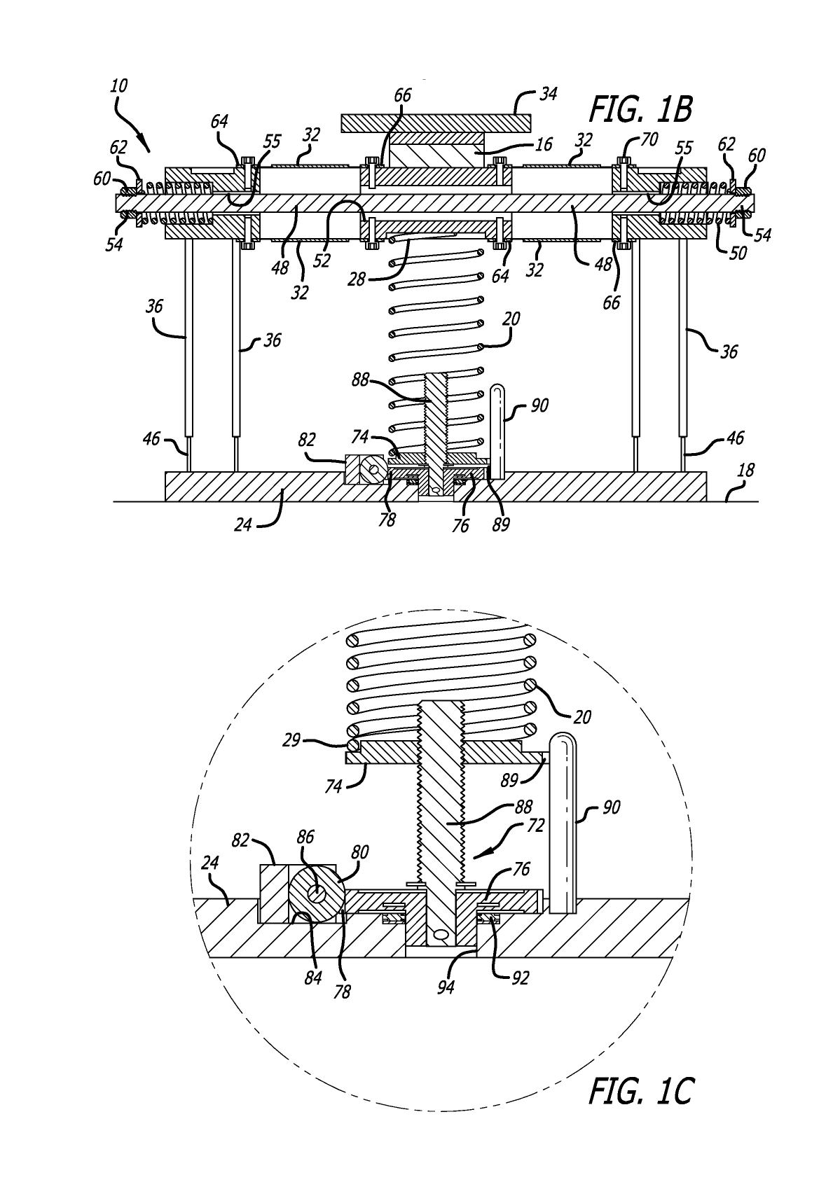

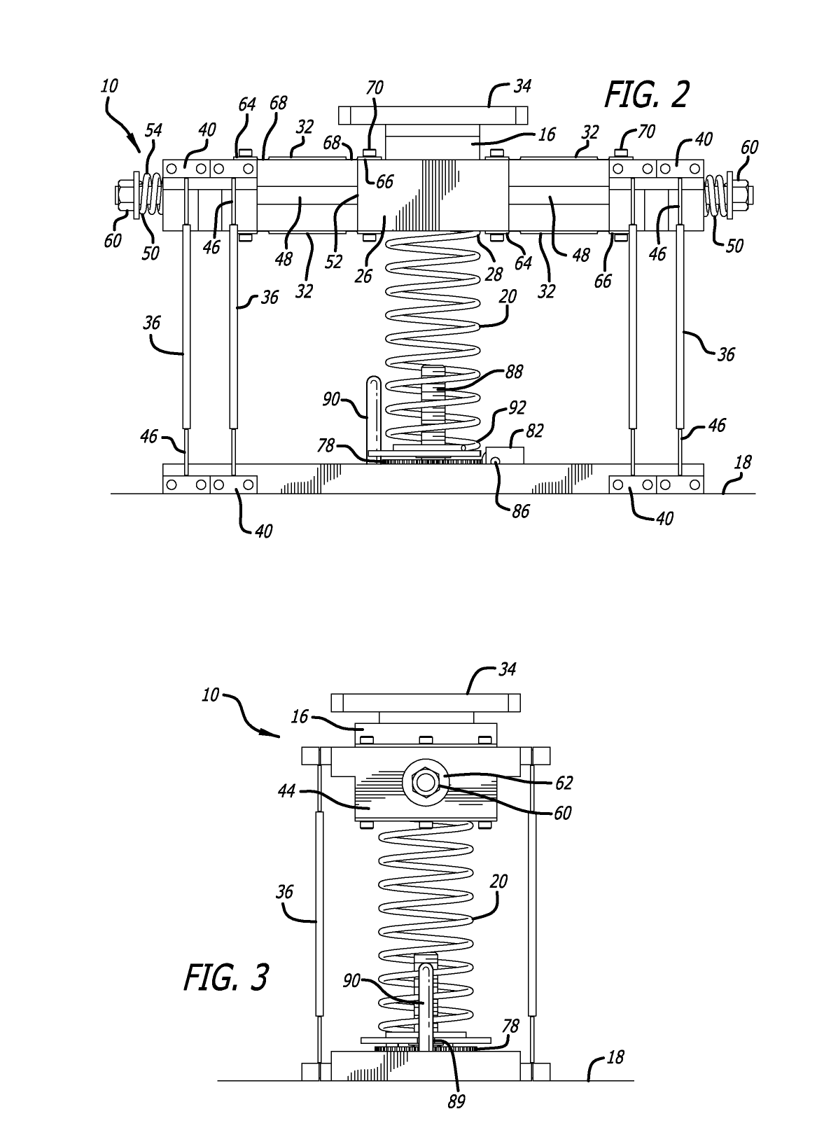

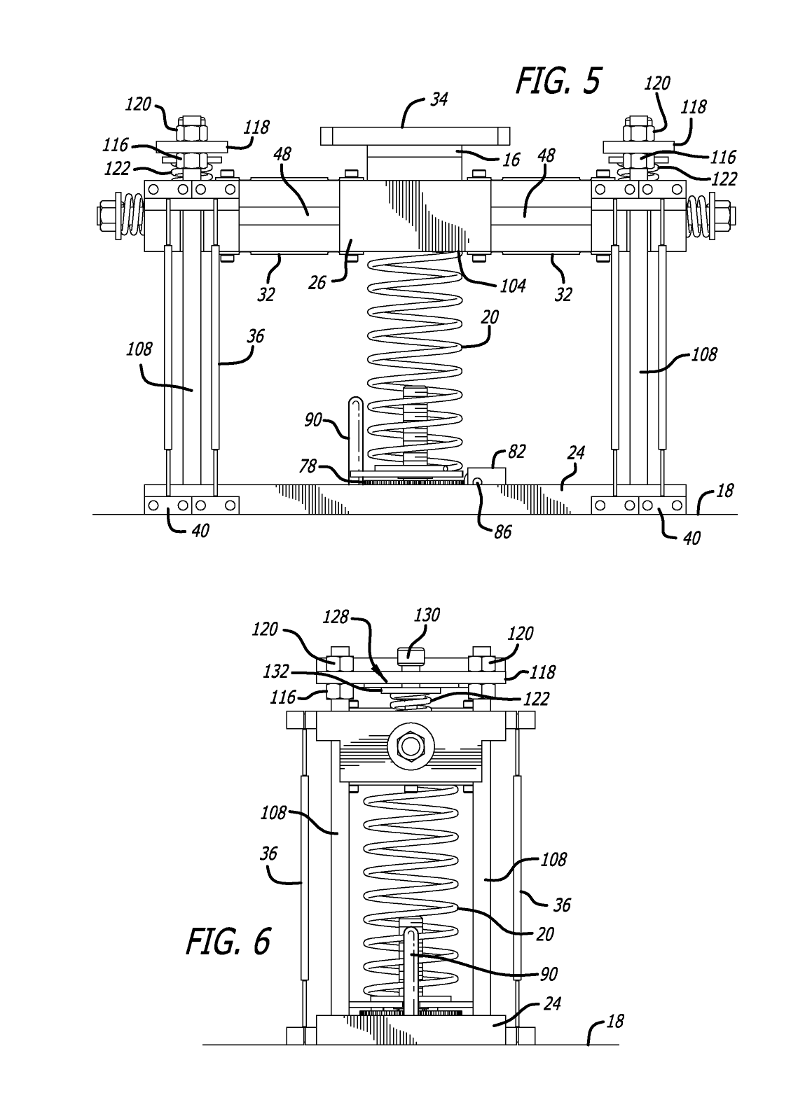

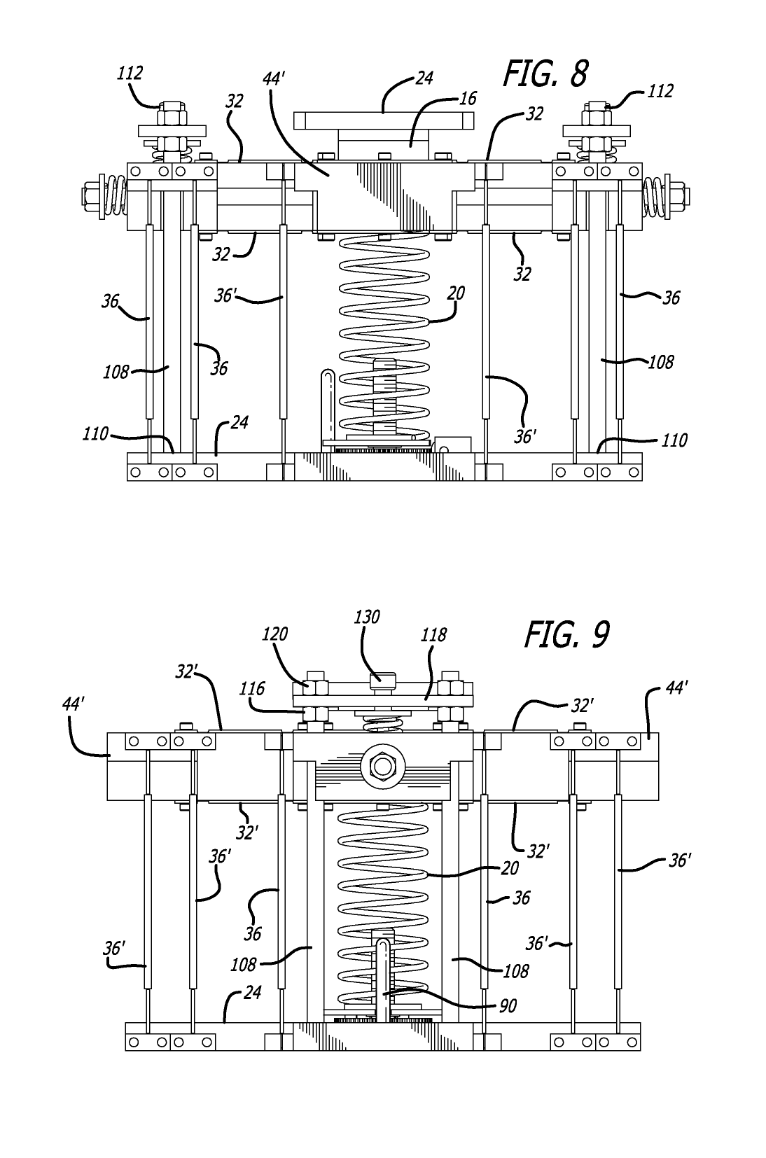

As is shown in the drawings for purposes of illustration, the present invention is embodied in a vibration-isolating suspension system comprising a payload platform supported on a vertical-motion, horizontal-motion and tilt-motion isolator. The improvements of the present invention are found in several embodiments of a composite isolator as shown in FIGS. 1A-9. As the present invention is described in detail as applied to the particular isolators shown in these figures, those skilled in the art will appreciate that these improvements can also be used in conjunction with other isolators as well.

FIGS. 1A-3 show one embodiment of a vibration isolation system 10 made in accordance with the present invention. The system utilizes a vertical-motion isolator 12, a horizontal-motion isolator 14 and a tilt-motion isolator 16. The embodiment of the isolator system 10 of FIGS. 1A-3 is designed to support a payload (not shown) relative to a foundation 18 to reduce the transmission of omnidirectional vibrations between the payload and foundation.

The vertical-motion isolator 12 of the present invention includes a support member in the form of a coil spring 20 that is operatively connected between a center hub assembly 22 and a base plate 24 that sits on the foundation 18. This base plate 24 may include leveling screws (not shown) which could be used for leveling the base plate 24 relative to the foundation 18. The center hub assembly 22 includes a center hub 26 which is coupled to one end 28 of the support spring 20. A negative-stiffness-producing mechanism 30 is connected to the center hub assembly 20 to cancel stiffness from the support spring 20 and includes axially-compressed flexures 32 connected at their inner ends to the center hub 26 and at their outer ends to spring blocks 44 that are supported on sets of beam-columns 36. The beam-columns 36 essentially prevent the spring blocks 44 from moving vertically or in tilt. In my previous patents the spring blocks were supported on rigid support posts or vertically oriented sheet metal flexures. The negative-stiffness-producing mechanism operates in the same manner as the particular mechanisms disclosed in my previous patents, particularly, U.S. Pat. Nos. 5,669,594 and 5,833,204.

A top mounting plate 34 is coupled to the center block 26 and is used to support the object (not shown) to be isolated from vibrations. The tilt-motion isolator 16 can be placed between the top mounting plate 34 and the center block 26 to provide tilt-motion isolation to the system. As can be seen in FIGS. 1A-3, this tilt-motion isolator 16 can be made, for example, from a damper pad which provides a simple and economical means for providing tilt stiffness capability to the composite isolation system 10. The damper pad provides for more compact design by using less vertical space than say, a flexure assembly. Alternatively, the tilt-motion isolator could be made from a flexure assembly, such as the one disclosed in my U.S. Pat. No. 5,669,594.

The horizontal-motion isolator 14 comprises a number of vertically oriented beam-columns 36, which are in the form of thin cylindrical rods, as well as the support spring 20 that provides some of the horizontal stiffness of the horizontal-motion isolator. Each beam-column 36 includes a bottom end 38 secured to the base plate 24 via an end fitting 40. The top ends 42 of the beam-columns 36 are, in turn, secured in end fittings 40 that are attached to a spring block 44 which forms a part of the negative-stiffness-producing mechanism 30. In the embodiment of FIGS. 1A-3, each beam-column 36 has a pair of notches 46 machined or otherwise formed therein near their bottom and top ends 38, 42. As can be seen in FIGS. 1A-3, there are two spring blocks 44 associated with the negative-stiffness-producing mechanism 30. In this particular isolator, the beam-columns are designed to support the spring blocks 44 of the negative-stiffness-producing mechanism 30. However, these beam-columns 36 are not designed to support any of the weight of the object to be isolated. Rather, the entire weight of the payload is born by the support spring 20. In this particular embodiment of the invention, the beam-columns 36 can be selected to have low horizontal stiffness without the need to rely on the beam-column effect that results when the beam-columns support the payload weight of the object to be isolated, as is disclosed in my previous horizontal-motion isolators. The support spring 20 in this embodiment can also be selected to provide low horizontal stiffness. The supported payload and the entire upper part of the isolator, including the top plate 34, the tilt-motion isolator 16, the center block 26, the axially-compressed flexures 32, the spring blocks 44, and the axially-compressed-flexure compression mechanism, all can oscillate horizontally in any horizontal direction at low natural frequencies on the beam-columns 36 and the support spring 20.

As can be best seen in FIG. 1B, four notched flexures 32 are attached to a center hub 26 and the spring blocks 44 and are compressed using a tension bolt 48 and a pair of compression springs 50 which form a portion of the negative-stiffness-producing mechanism. The tension bolt 48 is designed to extend through an opening 52 which extends through the center hub 26. The free ends 54 of the bolt are threaded and extend through openings 55 formed in each spring block 44. The end 56 of each compression spring 50 can be placed into a recessed cavity 58 formed in the spring block 44 in order to hold the spring in place. A nut 60 and washer 62 at the threaded end 54 of the tension bolt 48 are used to squeeze each compression spring 50 against its respective spring block 44 to achieve a compressive force on each flexure 32. A thrust bearing (not shown) could be placed between the nut 60 and the end of the compression spring 50, if needed.

Each nut 60 can be rotated accordingly to impart the needed compressive force to each of the flexures 32. Each flexure 32 has a first end 64 and a second end 66 having a notch 68 machined or otherwise formed in close proximity to these first and second ends 64, 66. Each flexure 32 is attached to the spring block 44 and center hub 26 using conventional fastening means, such as screws 70, which extend though openings formed on the ends of the flexures. Preloading of the flexures and fine tuning of the load to adjust the negative-stiffness effect are accomplished by simply turning each nut 60, as may be needed. This arrangement of a tension bolt, die springs and fasteners is just one of a number of ways to load the flexures 32.

Referring particularly to FIGS. 1A-1C, the vertical-motion isolator 12 includes a worm gear assembly lift mechanism 72 that raises or lowers the ends 28 and 29 of the support spring 20 to accommodate changes in weight load on the isolator. As can be seen in these figures, the worm gear assembly lift mechanism 72 includes a support plate 74 upon which the support spring 20 sits. A worm gear 76 having outer threads engages the threads of a worm 80 that is located within a housing 82. This housing 82 sits within a recess 84 formed on the base plate 24. The worm gear assembly lift mechanism 72 utilizes a screw 86 which is used to turn the worm 80 in order to rotate the worm gear 76. The worm gear 76, in turn, is designed to rotate a threaded post 88 which is rotatably mounted to the base plate 24. The support plate has a slot 89 which engages another upright post 90 fastened to the base plate 24 to prevent the support plate 74 from rotating as the support plate 74 moves in an upward/downward fashion. The worm gear 76 can sit on a suitable bearing 92 located within a recess 94 formed in the base plate 24. The support plate 76 has internal threads which mate with the threads formed on the support post 88. As a result, the rotation of the worm gear 76 via the worm 80 will cause the support plate 74 and support spring 20 to move in either an upward or downward fashion since these components move as the post 88 rotates with the gear 76. As a result, the positioning of the bottom end 29 and top end 28 of the support spring 20 can be easily adjusted to accommodate different weight loads. This lift mechanism 72 allows the top end 28 of the support spring 20 to be lifted, as needed, to keep the flexures 32 substantially straight and the vertical motion isolation system nearly in its center position for optimum performance.

The present invention eliminates the need for components such as, for example, the upper and lower column plates and support shafts associated with the horizontal-motion isolators along with the vertically oriented sheet metal flexures associated with the vertical-motion isolators disclosed in my previous patents. As a result, the costs for manufacturing an efficient low-frequency vibration isolation system made in accordance with the present invention can be reduced.

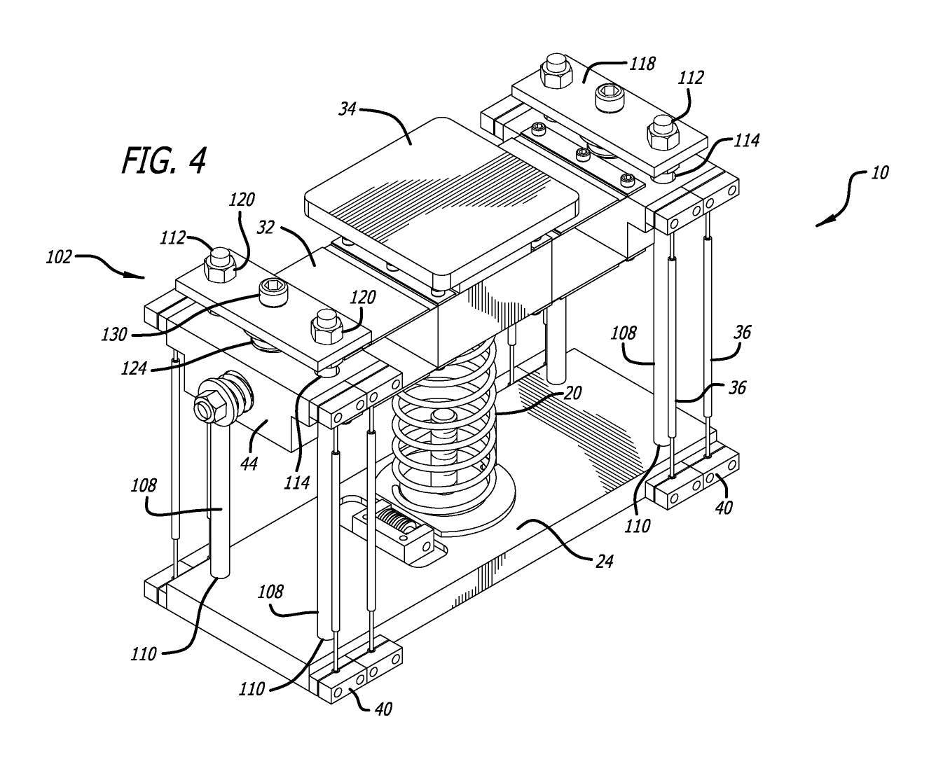

Referring now to FIGS. 4-6, another embodiment of a vibration isolation system 10 is shown. In this particular embodiment, the vertical-motion isolator 12 is the same as the one shown in FIGS. 1A-3. The horizontal-motion isolator 16 is substantially the same as the one shown in FIGS. 1A-3 except it further includes a loading mechanism 102 (“horizontal stiffness adjustment mechanism”) which is designed to apply a loading force on each of the beam-columns 36. In this particular embodiment, as with the previously described embodiment above, the beam-columns 36 do not support the weight of the payload, but they do rely on the beam-column effect to change the horizontal stiffness of the beam-columns and the support spring 20 in order to produce an isolator that effectively isolates horizontal vibration. In this manner, the loading mechanism 102, rather than the weight of the payload, is utilized to produce the beam-column effect on the beam-columns 36 which reduces the horizontal stiffness of the beam-columns 36 and the support spring 20. The amount of the load applied to the beam-columns 36 via the loading mechanism 102 can be varied, as needed, in order to obtain the desired amount of horizontal stiffness for the system. For example, the beam-columns could be sufficiently loaded to reduce the horizontal stiffness in the beam-columns themselves or additional loading could be placed on the beam-columns to produce negative stiffness that helps to reduce the horizontal stiffness associated with the support spring 20. Since the other components of the vibration isolation system 10 shown in FIGS. 4-6 are identical to the components described in the embodiment of FIGS. 1A-3, it is believed there is no need to repeat the detailed description of these components again in conjunction with the embodiment disclosed in FIGS. 4-6.

The loading mechanism 102 provides a simple horizontal stiffness adjustment to the horizontal-motion isolator 14 to allow the user to easily “fine tune” the horizontal stiffness exhibited by the beam-columns 36 and the support spring 20. The loading mechanism 102 includes a pair of support rods 108 associated with each spring block 44. Each support rod 108 includes one end 110 which extends into the base plate 24 and a free end 112 which extends through an opening 114 in the spring blocks 44. These openings 114 are best seen in the spring blocks 44 shown in FIGS. 1A-3 which do not incorporate a loading mechanism, but could, if desired. Each end 112 of the support rod 108 is threaded so that a nut 116 can be used as a stop for supporting a mounting plate 118. Another nut 120 located just above the mounting plate 118 maintains the mounting plate 118 secured to each support rod 108. The loading mechanism 102 further includes a compression spring 122 placed between the mounting plate 118 and the spring block 44. One end of the compression spring 122 can be placed within a recess 124 found on the top surface of the spring block 44. This recess 124 can best seen in the spring blocks 44 shown in FIG. 1A. The other end 126 of the compression spring 122 is in contact with a screw mechanism 128 associated with the mounting plate 118. The screw mechanism 128 includes a turn screw 130 and an abutting structure 132 which contacts the end 126 of the compression spring 122. The turn screw 130 can includes threads that engage threads cut into an opening in the mounting plate 118. This turn screw 130 can be rotated to cause the abutting structure 132 to compress the compression spring 122 in order to develop a compressive force acting on the spring block 44, which, in turn, is transferred to each of the beam-columns 36 associated with that particular spring block 44. The turn screw 130 can be simply rotated to obtain the desired amount of compressive force needed to be applied to the beam-columns 36. Since the screw mechanism 128 is connected to mounting plate 118 which is connected to the base plate 24 through support rods 108, the horizontal stiffness of the compression spring 122 also contributes to the horizontal stiffness of the horizontal-motion isolator since the compression spring 122 deforms laterally as the spring blocks 44 move horizontally relative to the base plate 24. The horizontal stiffness of the compression spring 122 also can be reduced by the beam-column effect produced by the loading mechanism 102.

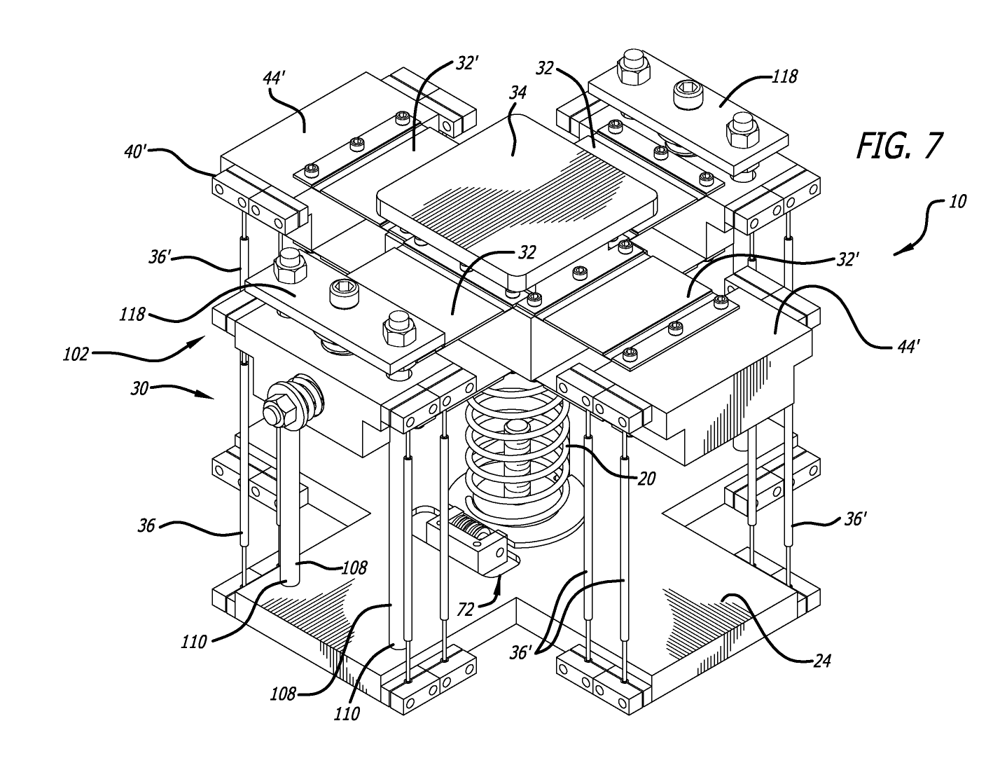

Referring now to FIGS. 7-9, another embodiment of a vibration isolation system 10 made in accordance with the present invention is shown. This particular embodiment is very similar to the embodiment depicted in FIGS. 4-6 except this system utilizes four sets of spring blocks and associated components, rather than the two sets, as is shown in the previous embodiments. The components which make up the vertical-motion isolator 12 include the negative-stiffness-producing mechanism 30 and lift mechanism 72 which are the same components as the previously described embodiments of FIGS. 4-6. Likewise, the horizontal-motion isolator 14 includes the same vertically oriented beam-columns 36 and loading mechanism 102 for providing horizontal stiffness adjustment to the system.

As can be seen in FIGS. 7-9, this particular embodiment utilizes flexures 32 which are connected to negative-stiffness-producing mechanisms 30 and flexures 32′ which are free standing and not connected to a negative-stiffness-producing mechanism. Likewise, there are beam-columns 36 which are connected with loading mechanisms 102 and other sets of beam-columns 36′ which stand alone. These “free standing” flexures 32′ and beam-columns 36′ are utilized to provide additional lateral stability to the composite system, especially if a large payload is being supported by the support spring 20. Alternatively, these free standing flexures 32′ and beam-columns 36′ could be attached to negative-stiffness-producing mechanisms and loading mechanisms, respectively, if desired. It should be appreciated that various types of support springs could alternatively be used in place of support spring 20 in the embodiments of FIGS. 4-6 and 7-9, such as flat wire coil springs, die springs and bellows springs.

In all of the embodiments disclosed herein, a pair of beam-columns is used to support one end of each spring block. Accordingly, four beam-columns are shown supporting each spring block. It should be noted that more or less beam-columns could be utilized to support the spring block without departing from the spirit and scope of the present invention. The beam-columns also could be uniform in diameter rather than having notches formed their ends.

The elements making up the present structure can be made from common structural materials such as steel and aluminum alloys. Other structural materials having suitable strength, elastic and mass properties can also be used.

The damper pad of the tilt motion isolator can be made from various elastomers or rubber like materials to provide a wide range of stiffness and damping. Examples are silicone rubber and Sorbothane® (manufactured by Sorbothane, Inc., Kent, Ohio). Stiffness and damping can be varied by changing the particular material, material durometer, pad size and shape (e.g., diameter, square or rectangle), pad thickness, etc. Also, multiple pads can be used to vary vertical, horizontal and tilt stiffnesses. If creep is a problem in the isolator, the elastomeric damper pads can also be used with metal springs in parallel to alleviate or help alleviate some of the problems caused by creep.

While particular forms of the invention have been illustrated and described, it will be apparent that various modifications can be made without departing from the spirit and scope of the invention. Accordingly, it is not intended that the invention be limited, except by the attached claims.

I claim:

1. An omnidirectional vibration-isolating suspension apparatus for supporting an object in an equilibrium position relative to a base while suppressing transmission of vibratory motion between the object and the base in a vertical direction and in any horizontal direction, and having low stiffness in the vertical direction and in any horizontal direction, comprising:
a vertical-motion isolator that includes a support spring that supports the weight of the object, and a mechanism for producing negative stiffness in the vertical direction operatively connected with the support spring, wherein the support spring and the negative-stiffness-producing mechanism combine to produce the low vertical stiffness; and
a horizontal-motion isolator that includes a plurality of vertically oriented beam-columns supporting none of the weight of the object.

2. The omnidirectional vibration-isolating suspension apparatus of claim 1, wherein the horizontal-motion isolator also includes the support spring.

3. The omnidirectional vibration-isolating suspension apparatus of claim 2, wherein the support spring and the beam columns have low horizontal stiffness.

4. The omnidirectional vibration-isolating suspension apparatus of claim 1 further including a loading mechanism that reduces the horizontal stiffness of the beam-columns.

5. The omnidirectional vibration-isolating suspension apparatus of claim 4, wherein the loading mechanism applies compressive force on the beam-columns.

6. The omnidirectional vibration-isolating suspension apparatus of claim 4, wherein the support spring has relatively high torsional stiffness.

7. An omnidirectional vibration-isolating suspension apparatus for supporting an object in an equilibrium position relative to a base while suppressing transmission of vibratory motion between the object and the base in a vertical direction and in any horizontal direction, and having low stiffness in the vertical direction and in any horizontal direction, comprising:
a vertical-motion isolator that includes a support spring that supports the weight of the object, and a mechanism for producing negative stiffness in the vertical direction operatively connected with the support spring, wherein the support spring and the negative-stiffness-producing mechanism combine to produce the low vertical stiffness; and
a horizontal-motion isolator that includes a plurality of vertically oriented beam-columns supporting at least a portion of the vertical-motion isolator negative-stiffness-producing mechanism.

8. The omnidirectional vibration-isolating suspension apparatus of claim 7, wherein the horizontal-motion isolator also includes the support spring.

9. The omnidirectional vibration-isolating suspension apparatus of claim 8, wherein the support spring and the beam columns have low horizontal stiffness.

10. The omnidirectional vibration-isolating suspension apparatus of claim 7 further including a loading mechanism that reduces the horizontal stiffness of the beam-columns.

11. The omnidirectional vibration-isolating suspension apparatus of claim 10, wherein the loading mechanism applies compressive force on the beam-columns.

12. The omnidirectional vibration-isolating suspension apparatus of claim 10, wherein the support spring has relatively high torsional stiffness.
